(19) United States
(12) Patent Application Publication
(10) Pub. No.: US 2025/0356215 A1
(43) Pub. Date: Nov. 20, 2025

(54) METHOD FOR OPTIMIZING MODEL OPERATION THROUGH WEIGHT ARRANGEMENT AND COMPUTING SYSTEM THEREOF

(71) Applicant: REALTEK SEMICONDUCTOR CORP., HSINCHU (TW)

(72) Inventors: CHIEN-HAO CHEN, HSINCHU (TW); CHIH-WEI WU, HSINCHU (TW); SHIH-TSE CHEN, HSINCHU (TW)

(21) Appl. No.: 19/206,176

(22) Filed: May 13, 2025

(30) Foreign Application Priority Data
May 16, 2024 (TW) 113118027

(51) Int. Cl. G06N 3/0985

(52) U.S. Cl. CPC G06N 3/0985

(57) ABSTRACT

A method for optimizing model operation through weight arrangement and a computing system are provided. The method is operated in an operating device. In the method, a model framework is decided, and a training set is provided according to the model framework for training a model through a learning algorithm. A plurality of weights are computed for the model. The computing system relies on characteristics of the weights to select one of weight-arrangement rules, or a combination of the weight-arrangement rules, so that the locations of all or part of the weights can be re-arranged based on the selected weight-arrangement rule. The re-arranged weights are referred to for designating a corresponding loss function for simplifying the algorithm of the model. An application device can accordingly operate the model.

### CROSS-REFERENCE TO RELATED PATENT APPLICATION

This application claims the benefit of priority to Taiwan Patent Application No. 113118027, filed on May 16, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to optimization for model operation, and more particularly to a method for optimizing the model operation through weight re-arrangement in a specific arrangement rule according to weight characteristics obtained from a well-trained model, and a computing system thereof.

### BACKGROUND OF THE DISCLOSURE

Nowadays, an intelligence mode is widely used by a supervised learning process. Newly collected data or existing data is used for training the model. Various open platforms such as Pytorch and TensorFlow are provided for a user to define a model framework and loss function so as to complete the supervised learning process for training the model by a gradient descent method.

Reference is made to FIG. 1, which is a flowchart of a conventional process of model training. In the beginning, a model framework and loss function are defined through a specific platform for training models (step S101). Next, a deep-learning algorithm is performed on a training set that is formed by the collected data or the existing data for training the model (step S103). To train an object function for maximizing or minimizing the object function, the deep-learning algorithm is used to train the object function of a model. The object function is such as the loss function. Most of the factors determining the quality of the model are related to a design of the loss function. The basic purpose of the model training is to minimize the loss function.

For preventing overfitting when the model is learning, one of the common methods is to add a regularization operation in the process of model training for preventing the overfitting (step S105). After that, weights for the model are obtained in the process of deep-learning (step S107). However, the regularization can easily make part of the weights of the trained model very small and cause the part of the weights to have very small contribution to an entire model. Therefore, in some conventional technologies, a model pruning process is performed on a model that is completely trained (step S109). The weight undergoing the model pruning process is set to 0 and the weight becomes a value whose operation can be ignored. Accordingly, it is possible to improve speed for model operation. Thus, a model is formed through a simplification operation (step S111).

One of the reasons to improve performance of the above-mentioned model pruning process is as follows. Even though the current types of model frameworks are ever changing, a multiply-accumulate operation (MAC) is still common. The multiply-accumulate operation (MAC) can be simplified as an equation of “I₁·W₁+I₂·W₂+I₃·W₃+I₄·W₄+ . . . ”, in which “I” represents an input value and “W” represents a weight. If some weights are of a very small value, the weights have poor contribution in the multiply-accumulate operation and can therefore be pruned to 0 that allows the operation to ignore the process of multiplying by 0. The performance of the overall operation can be improved.

However, the pruned weight (set to 0) is essentially determined according to a size of the weight. The size of the weight is learned by a model itself in a training process. In a common hardware design that is able to process multiple multiply-accumulate operations in parallel at once, duplicate weights or the weights with very small values can randomly appear in the multiple multiply-accumulate operations and is therefore hard to optimize. For example, if the hardware is capable of performing eight sets of the multiply-accumulate operations, even if two of the sets of multiply-accumulate operations can be neglected since they are multiplied by 0, there are still six remaining sets of multiply-accumulate operations to be completed. In other words, there is no explicit rule to determine which of the trained weights will be pruned. Thus, improvements to the efficiency of the model operation can be quite limited in the common hardware design, or the efficiency can only be improved by designing the hardware together with the operations in mind. This means that the benefits are quite limited when the model is applied to a general-purpose hardware.

### SUMMARY OF THE DISCLOSURE

In response to the above-referenced technical inadequacies, provided in the present disclosure is a method for optimizing model operation through weight arrangement and a computing system. In the method, characteristics of weights that are randomly formed and arranged are obtained, and the weights are re-arranged according to the characteristics of the weights. After that, the weights can be used to optimize performance of model operation through a loss function that is designed by a simplification operation.

According to one embodiment of the present disclosure, the method for optimizing model operation through weight arrangement operated in the computing system can be performed in an operating device. In the method, a model framework is firstly decided based on a requirement. A learning algorithm employs a training set to train a model based on the model framework, and multiple weights for the model can be calculated. Characteristics of the weights can then be obtained. Afterwards, one of weight-arrangement rules or a combination of multiple of the weight-arrangement rules is selected according to the characteristics of the weights. Next, positions of all or part of the multiple weights can be re-arranged according to the selected weight-arrangement rule. A corresponding loss function can be designed based on the re-arranged weights so as to simplify the operation of the model. The model is then applied to an application device.

Further, in a process of training the model, a regularization operation is performed on the multiple weights for reducing complexity of the model and ensuring that the model won't be overfitting.

In the method, a statistical method is used to obtain characteristics of the multiple weights. For example, a histogram that can show a weight distribution of the weights can be used to obtain the characteristics thereof.

The histogram shows a first quantity of the weights having the same value; or the histogram shows the plurality of weights having a symmetrical distribution that indicates a second quantity of weights having the same but with opposite positive and negative values; and/or the histogram shows a third quantity of weights of zeros.

Further, according to the characteristics of the multiple weights, the one of the weight-arrangement rules or the combination of the weight-arrangement rules is applied to the multiple weights for arranging the weights with the same value together, arranging the weights with the same but opposite positive and negative values together, and/or arranging the weights of zeros to fixed positions. Thus, a corresponding loss function is then designed for simplifying a multiply-accumulate operation for the model.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart illustrating a conventional process of model training;

FIG. 2 is a schematic diagram illustrating a framework of a computing system that operates the method for optimizing model operation through weight arrangement according to one embodiment of the present disclosure;

FIG. 3 is a diagram depicting a distribution of weights that are obtained by model training;

FIG. 4 is a flowchart illustrating a method for optimizing model operation through weight arrangement according to one embodiment of the present disclosure;

FIG. 5 is a schematic diagram illustrating a weight-arrangement rule in one embodiment of the present disclosure;

FIG. 6 is another schematic diagram illustrating the weight-arrangement rule in another embodiment of the present disclosure; and

FIG. 7 is one further schematic diagram illustrating the weight-arrangement rule in one further embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method for optimizing model operation through weight arrangement and a computing system that performs the method. The computing system can be a circuitry or firmware operated in a computer system. A technical concept of the method is to obtain characteristics of weights that are randomly formed and arranged without applying any specific arrangement rule. Based on the characteristics of the weights for a well-trained model, a specific arrangement rule is applied to re-arrange the weights for model operation. A corresponding loss function can be designed for simplifying operation of the model so as to improve performance of model operation.

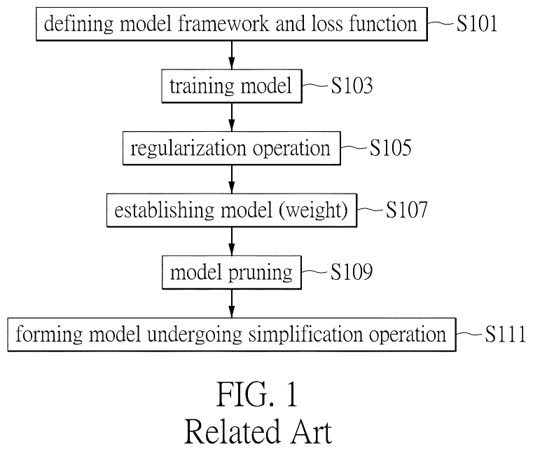

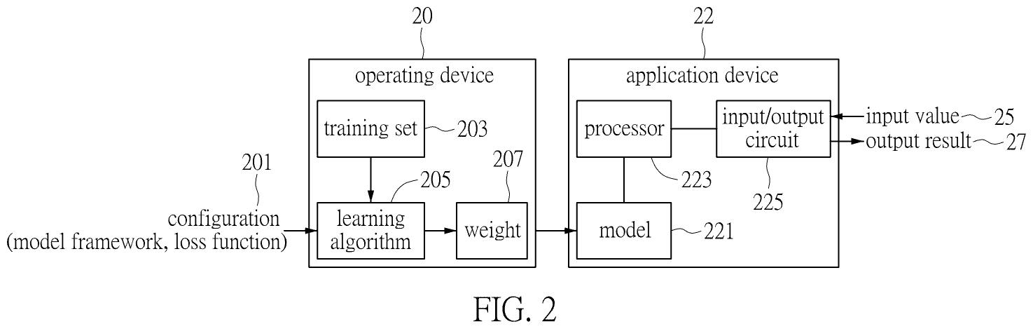

Reference is made to FIG. 1, which is a schematic diagram illustrating a framework of the computing system that operates the method for optimizing model operation through weight arrangement according to one embodiment of the present disclosure. The computing system essentially includes an operating device 20 that is used to perform model training and weight arrangement, and an application device 22 that is used to apply a trained model.

According to a requirement for training the model, a configuration 201 made to a model framework and a loss function is provided. In the operating device 20 implemented by a computer system, a training set 203 is formed by collecting a significant amount of data or using existing data. A specific learning algorithm 205 using the training set 203 is used to train the model. As such, an intelligence model for a specific purpose can be obtained. In one embodiment of the present disclosure, in a process of training the model with a neural network, weights of the nodes of the neural network are retrieved for forming the weights 207 of the model. A loss function can be used to optimize the model in the process of model training. In other words, the loss function is used to measure a residual between a model prediction value and an actual target value. One of the purposes of the loss function is to reduce the residual by adjusting the weights of the model. Finally, the weights 207 for the intelligence model are obtained. In the process of training the model with the learning algorithm 205 and applying the loss function, regularization can be used to restrict some parameters in the loss function so as to prevent overfitting.

After the training process, a model 221 can be established. The model 221 can be applied to a specific application device 22 based on its purpose. An operating circuit such as a processor 223 of the application device 22 operates the model 221. The application device 22 receives an input value 25 via an input/output circuit 225, and the model 221 is operated to multiply every input value 25 and a weight on a node. Afterwards, an output result 27 is outputted via the input/output circuit 225. Thus, the output result 27 can be used verify the model 221 and can be used to design evaluation indicators based on a requirement. For example, the output result 27 can be referred to for evaluating a residual between an actual target value and a prediction value obtained from the model 221. Further, the evaluation result can be used to adjust the weights for the model 221 so as to optimize the model 221.

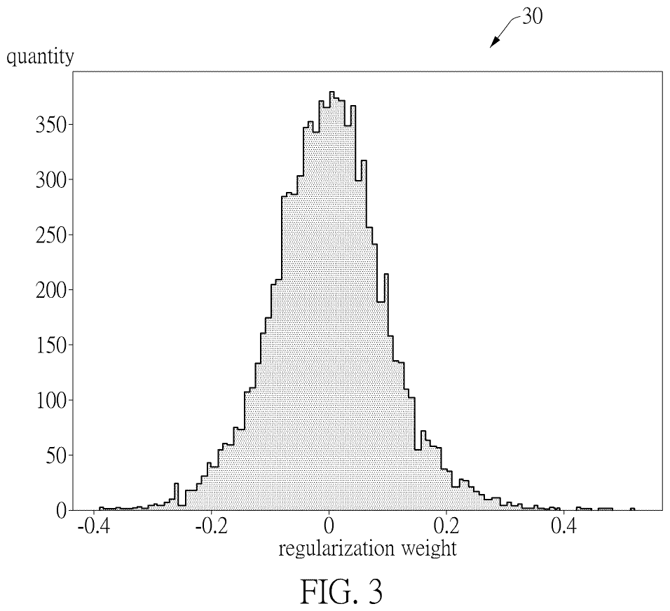

In particular, the weight distribution obtained in the process of model training originally has no rule. However, an exemplary histogram shown in FIG. 3 showing the weight distribution can be obtained by the statistical method after the process of model training. The histogram can be stored to a memory of the operating device, and can be used for the purpose of analyzing the weight characteristics. The weight characteristics can also be stored and dynamically updated with the model framework.

FIG. 3 exemplarily shows a weight distribution chart 30. A horizontal axis of the weight distribution chart 30 indicates the weight values ranging from −0.4 to 0.4 that are generated in a regularization operation. A vertical axis of the weight distribution chart 30 indicates a quantity of each of the weights. A statistical result as shown in FIG. 3 shows that a lot of duplicate numerical values and a lot of extremely small values are present in the weight distribution chart 30.

Thus, in the method for optimizing model operation through weight arrangement, for the hardware capable of processing multiple multiply-accumulate operations in parallel at once, an arrangement rule for the weights can be configured for re-arranging the weights in an actual operation according to a predetermined rule. Therefore, many duplicate weights or the weights with extremely small values can be re-arranged to optimize performance of multiply-accumulate operation. For example, the above-mentioned predetermined rules are as follow. First, the weights with the same value are re-arranged together, or the positions of the weights in the operation are recorded. For example, the weights with the same value can be stored in a flash memory, a cache or a register of the operating circuit. Secondly, the weights with the same but opposite positive and negative values are re-arranged together, or the positions of the weights in the operation are recorded. The weights are also stored to a specific memory. Thirdly, the weights are set to zero based on the statistical values, and the weights are re-arranged together or the positions of the weights of zeros are recorded to the memory. Fourthly, the weights that are not restricted by any rule are re-arranged together, or the positions of the weights in the operation are recorded in the memory.

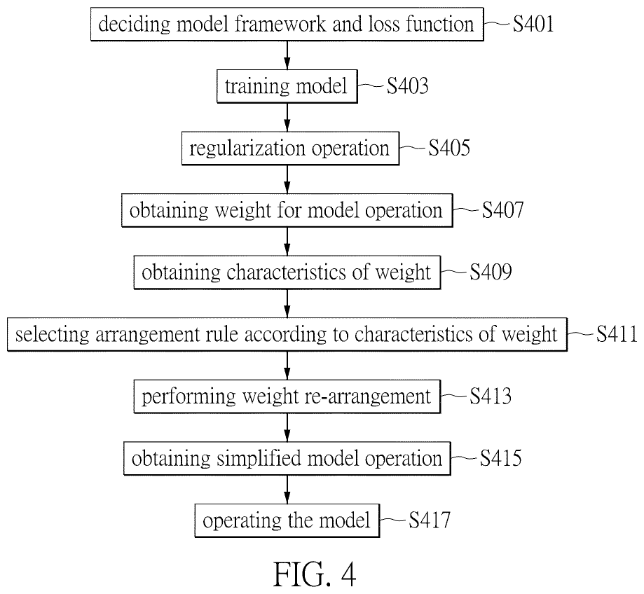

Reference is made to FIG. 4, which is a flowchart illustrating the method for optimizing model operation through weight arrangement according to one embodiment of the present disclosure.

In the beginning, a model framework and a loss function are decided according to a goal of training a model (step S401). Defining the model framework includes defining a framework of a neural network that is configured to perform learning. The loss function is designed for weighing a difference or an error between model prediction and the goal. Next, a deep learning algorithm uses a training set to train the model (step S403). In the process of model training, for preventing overfitting, a regularization operation is performed on the multiple weights for reducing complexity of the model and ensuring that the model does not overfit (step S405). It should be noted that the regularization operation is to add a constraint to the loss function for the model, so that a gradient descent method is performed in a process of model training for preventing overfitting due to weights being too large. For example, a model pruning method can be performed for preventing overfitting.

In the above process of model training, multiple weights for the model are calculated (step S407). Next, a statistical method is applied for obtaining characteristics of the weights. For example, a histogram depicted in FIG. 3 shows a distribution of the weights so as to obtain the characteristics of the weights (step S409).

For example, reference is made to the weight distribution chart 30 shown in FIG. 3. The histogram shows that the statistical weight values have a symmetrical distribution, which indicates that a certain quantity of weights therein are symmetrical. Accordingly, the certain quantity of weights (defined as a first quantity of weights) with the same value or with a negligible difference can be integrated into the operation, and the other certain quantity of weights (defined as a second quantity of weights) with the same (absolute value) but opposite positive and negative values include positive weights and negative weights with almost the same quantity. The weights with opposite positive and negative values can cancel out with each other in the operation. The histogram also shows that a central peak value is near the position where the weight value is zero. Further, another certain quantity of weights (defined as a third quantity of weights) are zeros after the regularization operation, and these weights can be ignored in the operation. Thus, the operation can be simplified based on, but not limited to, the above-described characteristics of the weights.

A result obtained by the above-mentioned statistical method can be used to determine the characteristics of the weights. The characteristics of the weights are referred to for selecting a predetermined weight-arrangement rule or a combination of multiple weight-arrangement rules for simplifying the operation. The rule or the combination of rules can be applied to the multiple weights (step S411). After that, according to a selected one of the weight-arrangement rules or a combination of multiple weight-arrangement rules, the positions of all or part of the weights for the model operation are re-arranged (step S413). In an exemplary example, the weights with the same value in the weights that are originally arranged in a random manner can be re-arranged together for simplifying the operation. Further, the weights with the same but opposite positive and negative values are also re-arranged together and the weights can cancel out with each other. The weights with a value of zero can be re-arranged at a fixed position, so that the circuit used to perform the operation can ignore the operation with respect to the weights at the specific positions. It should be noted that the characteristics of the weights and the computation for the loss function can be used as one of the factors to be considered for determining the positions of all or part of the weights in the model operation to be re-arranged. A final decision about the arrangement rule can be made after weighing the above-described factors. For example, the final decision can be that the arrangement rule is flexibly not applied to part of the weights, but the operation with the weights is performed in an original sequence.

Finally, the computing system obtains the re-arranged weights, and obtains a simplified model operation through the loss function (step S415). When the model is applied to a specific application, each of the input values is multiplied by a corresponding weight, and the model is operated based on the loss function with respect to the re-arranged weights (step S417).

One of the objectives to configure the weight-arrangement rules is because the original weight distribution generated by training the model does not have any arrangement rule. The disclosed method is configured to restrict the distribution of the weights in the process of model training. The model operation can be accelerated according to the predetermined arrangement rules.

The actual examples relating to the weight-arrangement rules are as follows.

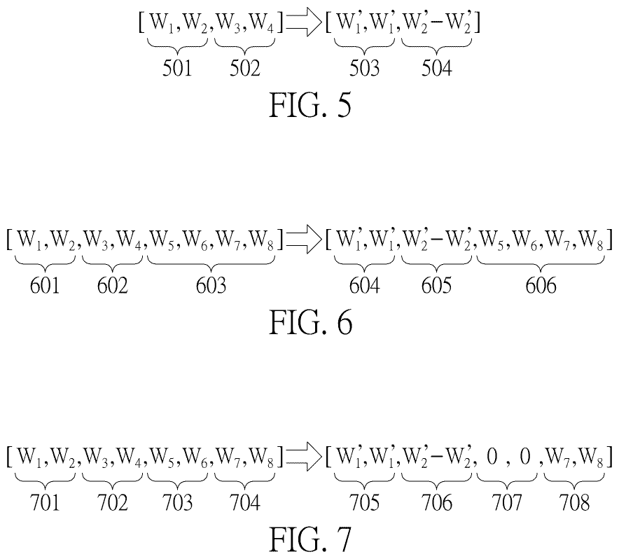

FIG. 5 is an example showing a first weight-arrangement rule.

The example shows that the weights are restricted in units of four weights. The first weight-arrangement rule is that the weights with the same value are arranged together, and that the first two weights should be the same; the absolute values of last two weights should also be the same; and the third and fourth weights are two opposite positive and negative values indicating that the two weights are the same but with opposite positive and negative signs. In the weights [W₁, W₂, W₃, W₄] in Equation 1, the weights “W₁” and “W₂” with the same value form a first set of weights 501. The weights “W′1” and “W′1” form a first set of re-arranged weights 503, and these two weights have the same value. Further, the weights “W₃” and “W₄” with the same but opposite positive and negative values form a second set of weights 502, so that the weights “W′₂” and “−W′₂” form a second set of re-arranged weights 504.

$$[ {W}_{1} , {W}_{2} , {W}_{3} , {W}_{4} ] \to [ {W}_{1}^{′} , {W}_{1}^{′} , {W}_{2}^{′} , - {W}_{2}^{′} ] . \qquad Equation 1$$

The first weight-arrangement rule shown in Equation 1 is referred to for designing a loss function loss function (loss_{rearrange}) shown in Equation 2.

$${loss}_{rearrange} = abs ( {W}_{1} - {W}_{2} ) + abs ( {W}_{3} + {W}_{4} ) . \qquad Equation 2$$

Thus, according to Equation 2, the operation relating to the weights with the same but opposite positive and negative values can be effectively reduced for simplifying the model operation. This means that, in the model operation, the multiply-accumulate operation can be simplified by the first weight-arrangement rule, and the Equation 2 can be simplified to be Equation 3. Lastly, the optimized model operation can be simplified from three addition operations and four multiplication operations to three addition operations and two multiplication operations.

$${I}_{1} \cdot {W}_{1} + {I}_{2} \cdot {W}_{2} + {I}_{3} \cdot {W}_{3} + {I}_{4} \cdot {W}_{4} = ( {I}_{1} + {I}_{2} ) \cdot {W}_{1}^{′} + ( {I}_{3} - {I}_{4} ) \cdot {W}_{2}^{′} . \qquad Equation 3$$

FIG. 6 shows an example of a second weight-arrangement rule that takes both accuracy of the model and flexibility for training the model into account so as to restrict the weights in units of eight weights. The second weight-arrangement rule is that the rule applied to the first four weights is the same with the example shown in FIG. 5, which arranges the weights with the same value together, and that the first two weights have the same value, the next two weights are with the same but opposite positive and negative values, and the last four weights are not restricted. As shown in Equation 4, the weight “W₁, W₂, W₃, W₄, W₅, W₆, W₇, W₈” include weights “W₁” and “W₂” that are with the same value (defined as a first set of weights 601), and these weights with the same value form the re-arranged weights “W′₁” and “W′₁” that are defined as a first set of re-arranged weights 604. The weights shown in Equation 4 include the weights “W₃” and “W₄” that are the same but opposite positive and negative values (defined as a second set of weights 602), which form the weights “W′₂” and “−W′₂” that are defined as a second set of re-arranged weights 605. After that, there are four weights “W₅, W₆, W₇, W₈” that are defined as a third set of weights 603, which have no arrangement rule, and these weights form a third set of re-arranged weights 606.

$$Equation 4$$

$$[ {W}_{1} , {W}_{2} , {W}_{3} , {W}_{4} , {W}_{5} , {W}_{6} , \text{} {W}_{7} , {W}_{8} ] \to [ {W}_{1}^{′} , {W}_{1}^{′} , {W}_{2}^{′} - {W}_{2}^{′} , {W}_{5} , {W}_{6} , {W}_{7} , {W}_{8} ] .$$

Thus, the loss function that is designed according to the second weight-arrangement rule is shown in Equation 2. The multiply-accumulate operation (I₁·W₁+I₂·W₂+I₃·W₃+I₄·W₄+I₅·W₅+I₆·W₆+I₇·W₇+I₈·W₈) of the model can be simplified. As shown in Equation 5, the seven addition operations and eight multiplication operations are simplified to seven addition-subtraction operations and six multiplication operations.

$$Equation 5$$

$${I}_{1} \cdot {W}_{1} + {I}_{2} \cdot {W}_{2} + {I}_{3} \cdot {W}_{3} + {I}_{4} \cdot {W}_{4} + {I}_{5} \cdot {W}_{5} + {I}_{6} \cdot {W}_{6} + {I}_{7} \cdot {W}_{7} + {I}_{8} \cdot {W}_{8} = ( {I}_{1} + {I}_{2} ) \cdot {W}_{1}^{′} + ( {I}_{3} - {I}_{4} ) \cdot {W}_{2}^{′} + {I}_{5} \cdot {W}_{5} + {I}_{6} \cdot {W}_{6} + {I}_{7} \cdot {W}_{7} + {I}_{8} \cdot {W}_{8} .$$

FIG. 7 shows an example of a third weight-arrangement rule. The weights in the present example are restricted in units of eight weights. The third weight-arrangement rule is that the rule applied to the first four weights is the same with the examples shown in FIG. 5 or FIG. 6. For example, the weights having the same value are arranged together and it is ruled that the first two weights should have the same value, the next two weights should be the same but opposite positive and negative values, a first half of the last four weights is restricted to zero, and a second half of the last four weights are not restricted. As shown in Equation 6, the weights [W₁, W₂, W₃, W₄] include the weights “W₁” and “W₂” with the same value (defined as a first set of weights 701) that are re-arranged to be weights “W′₁” and “W′₁” defined as a first set of re-arranged weights 705. Next, the weights “W₃” and “W₄” defined as a second set of weights 702 that are the same but opposite positive and negative values, and form re-arranged to be the weights “W′₂” and “−W′₂” that are defined as a second set of re-arranged weights 706. The weights “W₅” and “W₆” that are defined as a third set of weights 703 are set to 0 so as to form a third set of re-arranged weights 707. Further, weights “W₇” and “W₈” that are defined as a fourth set of weights 704 are not restricted and can be any weight values that form a fourth set of re-arranged weights 708.

$$Equation 6$$

$$[ {W}_{1} , {W}_{2} , {W}_{3} , {W}_{4} , {W}_{5} , {W}_{6} , \text{} {W}_{7} , {W}_{8} ] \to [ {W}_{1}^{′} , {W}_{1}^{′} , {W}_{2}^{′} - {W}_{2}^{′} , 0 , 0 , {W}_{7} , {W}_{8} ] .$$

According to the third weight-arrangement rule shown in Equation 6, a first loss function (loss_{rearrange}) shown in Equation 7 is designed.

$$Equation 7$$

$${loss}_{rearrange} = abs ( {W}_{1} - {W}_{2} ) + abs ( {W}_{3} + {W}_{4} ) + abs ( {W}_{5} ) + abs ( {W}_{6} ) .$$

Thus, according to Equation 7, the computations for the weights with the same but opposite positive and negative values can be effectively reduced, and the computations for the weights of zeros can also be ignored. Accordingly, the model operation can be effectively simplified. That is, when the system is in model operation, the multiply-accumulate operation can be simplified by the third weight-arrangement rule, and the Equation 6 can be simplified to Equation 8 through the loss function shown in Equation 7. At last, the optimized model operation can simplify seven addition operations and eight multiplication operations to five addition-subtraction operations and four multiplication operations.

$$Equation 8$$

$${I}_{1} \cdot {W}_{1} + {I}_{2} \cdot {W}_{2} + {I}_{3} \cdot {W}_{3} + {I}_{4} \cdot {W}_{4} + {I}_{5} \cdot {W}_{5} + {I}_{6} \cdot {W}_{6} + {I}_{7} \cdot {W}_{7} + {I}_{8} \cdot {W}_{8} = ( {I}_{1} + {I}_{2} ) \cdot {W}_{1}^{′} + ( {I}_{3} - {I}_{4} ) \cdot {W}_{2}^{′} + {I}_{7} \cdot {W}_{7} + {I}_{8} \cdot {W}_{8} .$$

The above-described embodiments provide several examples of various weight-arrangement rules. The objective of the weight-arrangement rules is to re-arrange multiple weights according to characteristics of the weight distribution, and design a corresponding loss function for simplifying the model operation. The model generated through the simplified model operation can be operated in an application device that adopts general-purpose hardware. This kind of device has a general computing power having a multi-thread central processor or a graphics processor. The method for optimizing model operation through weight arrangement can be operated in this hardware for accelerating a well-trained model, and especially apply different weight-arrangement rules or any combination of multiple weight-arrangement rules in accordance with any of the different models with different weight distributions, so that the models can be operated simultaneously and the efficiency can be improved.

In conclusion, according to the above embodiments of the method for optimizing model operation through weight arrangement and the computing system, the computing system obtains characteristics of the weights that are obtained by training a model, and applies a specific weight-arrangement rule or a combination of multiple weight-arrangement rules to the weights. Accordingly, the weights with the same value are re-arranged together, the weights with the same but opposite positive and negative values are re-arranged together, and/or the weights of zeros are arranged at fixed positions. A loss function can then be designed based on the re-arranged weights and is used to optimize operation of the model.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for optimizing model operation through weight arrangement, performed in an operating device, comprising:
deciding on a model framework;
using a training set to train a model by a learning algorithm according to the model framework;
calculating multiple weights for the model;
obtaining characteristics of the multiple weights;
selecting one of weight-arrangement rules or a combination of multiple ones of the weight-arrangement rules according to the characteristics of the multiple weights;
re-arranging positions of all or part of the multiple weights according to the selected weight-arrangement rule or the combination of the multiple weight-arrangement rules; and
designing a corresponding loss function for simplifying an operation of the model according to the multiple re-arranged weights, and operating the model in an application device.

2. The method according to claim 1, wherein, in a process of training the model, a regularization operation is performed on the multiple weights for reducing complexity of the model and ensuring that the model does not overfit.

3. The method according to claim 1, wherein a statistical method is applied for obtaining characteristics of the multiple weights.

4. The method according to claim 3, wherein, according to the characteristics of the multiple weights, the one of the weight-arrangement rules or the combination of the weight-arrangement rules is applied to the multiple weights for arranging the weights with same value together, arranging the weights having same value but with opposite positive and negative signs together, and/or arranging the weights of zeros at fixed positions, so as to design a loss function that is used to simplify a multiply-accumulate operation of the model.

5. The method according to claim 3, wherein a histogram indicative of a weight distribution with respect to the multiple weights is established, and the characteristics of the weights are obtained according to the histogram.

6. The method according to claim 5, wherein, according to the characteristics of the multiple weights, the one of the weight-arrangement rules or the combination of the weight-arrangement rules is applied to the multiple weights for arranging the weights with same value together, arranging the weights with the same but opposite positive and negative values together, and/or arranging the weights of zeros to fixed positions, so as to design a loss function that is used to simplify a multiply-accumulate operation of the model.

7. The method according to claim 5, wherein the histogram shows a first quantity of the weights having a same value.

8. The method according to claim 5, wherein the histogram shows the multiple weights having a symmetrical distribution that indicates a second quantity of weights with the same but opposite positive and negative values.

9. The method according to claim 5, wherein the histogram shows a third quantity of weights being zeros.

10. The method according to claim 9, wherein, according to the characteristics of the multiple weights, the one of the weight-arrangement rules or the combination of the weight-arrangement rules is applied to the multiple weights for arranging the weights with the same value together, arranging the weights with the same but opposite positive and negative values together, and/or arranging the weights of zeros to fixed positions, so as to design a loss function that is used to simplify a multiply-accumulate operation of the model.

11. A computing system, comprising:
an operating device which performs a method for optimizing model operation through weight arrangement, wherein the method comprises:
deciding on a model framework;
using a training set to train a model by a learning algorithm according to the model framework;
calculating multiple weights for the model;
obtaining characteristics of the multiple weights;
selecting one of weight-arrangement rules or a combination of multiple ones of the weight-arrangement rules according to the characteristics of the multiple weights;
re-arranging positions of all or part of the multiple weights according to the selected weight-arrangement rule or the combination of the multiple weight-arrangement rules; and
designing a corresponding loss function for simplifying an operation of the model according to the multiple re-arranged weights, and operating the model in an application device.

12. The computing system according to claim 11, wherein, in a process of training the model, a regularization operation is performed on the multiple weights for reducing complexity of the model and ensuring that the model does not overfit.

13. The computing system according to claim 11, wherein a statistical method is applied for obtaining characteristics of the multiple weights.

14. The computing system according to claim 13, wherein, according to the characteristics of the multiple weights, the one of the weight-arrangement rules or the combination of the weight-arrangement rules is applied to the multiple weights for arranging the weights with the same value together, arranging the weights with the same but opposite positive and negative values together, and/or arranging the weights of zeros to fixed positions, so as to design a loss function that is used to simplify a multiply-accumulate operation of the model.

15. The computing system according to claim 13, wherein the multiple weights include a first quantity of the weights having a same value.

16. The computing system according to claim 15, wherein, according to the characteristics of the multiple weights, the one of the weight-arrangement rules or the combination of the weight-arrangement rules is applied to the multiple weights for arranging the weights with the same value together, arranging the weights with the same but opposite positive and negative values together, and/or arranging the weights of zeros to fixed positions, so as to design a loss function that is used to simplify a multiply-accumulate operation of the model.

17. The computing system according to claim 13, wherein the multiple weights include a second quantity of weights with a same value but opposite positive and negative signs.

18. The computing system according to claim 17, wherein, according to the characteristics of the multiple weights, the one of the weight-arrangement rules or the combination of the weight-arrangement rules is applied to the multiple weights for arranging the weights with the same value together, arranging the weights with the same but opposite positive and negative values together, and/or arranging the weights of zeros to fixed positions, so as to design a loss function that is used to simplify a multiply-accumulate operation of the model.

19. The computing system according to claim 13, wherein the multiple weights include a third quantity of weights being zeros.

20. The computing system according to claim 19, wherein, according to the characteristics of the multiple weights, the one of the weight-arrangement rules or the combination of the weight-arrangement rules is applied to the multiple weights for arranging the weights with the same value together, arranging the weights with the same but opposite positive and negative values together, and/or arranging the weights of zeros to fixed positions, so as to design a loss function that is used to simplify a multiply-accumulate operation of the model.
